(19) United States
(12) Patent Application Publication
(10) Pub. No.: US 2020/0055250 A1
(43) Pub. Date: Feb. 20, 2020

(54) UNPACKING DEVICE FOR ADDITIVELY FABRICATED MANUFACTURING PRODUCTS

(71) Applicant: EOS GmbH Electro Optical Systems, Krailling (DE)

(72) Inventor: Thomas Vodermair, Rimsting (DE)

(73) Assignee: EOS GmbH Electro Optical Systems, Krailling (DE)

(21) Appl. No.: 16/527,537

(22) Filed: Jul. 31, 2019

(30) Foreign Application Priority Data
Aug. 16, 2018 (DE) 102018119993.7

(51) Int. Cl. B29C 64/35; B33Y 30/00; B33Y 40/00; B29C 64/245; B29C 64/357; B33Y 50/02; B29C 64/393

(52) U.S. Cl. CPC B29C 64/35; B33Y 30/00; B33Y 40/00; B29C 64/393; B29C 64/357; B33Y 50/02; B29C 64/245

(57) ABSTRACT

Described is an unpacking device for a construction container of a device for additively fabricating manufacturing products, wherein the construction container has a continuous construction container wall and a height-adjustable build platform mounted therein, along with a method for controlling such an unpacking device. The unpacking device includes at least a receiving chamber, an unpacking chamber, a partition wall between the receiving chamber and unpacking chamber with a transfer opening, a construction container lifting device designed to move a construction container from a construction container receiving position into a construction container unpacking position, a build platform lifting device located in the receiving chamber and designed to move a build platform from a build platform initial position into a build platform unpacking position, and a control device for outputting at least one control signal to the construction container lifting device and build platform lifting device.

### TECHNICAL FIELD OF THE INVENTION

The invention relates to an unpacking device for a construction container of a device (hereinafter also referred to as manufacturing device) for additively fabricating manufacturing products, wherein the unpacking device has a receiving chamber for receiving a construction container, an unpacking chamber located above the receiving chamber, and a partition wall between the receiving chamber and unpacking chamber with a transfer opening. The invention further relates to a method for controlling such an unpacking device.

### BACKGROUND OF THE INVENTION

Additive manufacturing processes are becoming increasingly relevant during the manufacture of prototypes, and in the meantime for serial production as well. In general, “additive manufacturing processes” are to be understood as those manufacturing processes in which a manufacturing product or component is as a rule built up based upon digital 3D construction data, for example via the selective fusing of material. Buildup here most often takes place layer-by-layer, although this is not mandatory. The term “3D printing” is frequently also used as a synonym for additive manufacturing, with the production of models, patterns and prototypes often being referred to as “rapid prototyping”, and the production of tools as “rapid tooling”. As mentioned at the outset, a central point in numerous additive manufacturing processes involves the selective solidification of the build material, wherein this solidification can take place in many manufacturing processes through irradiation with radiant energy, e.g., electromagnetic radiation, in particular light and/or thermal radiation, but potentially also with particle radiation, such as electron radiation. Examples for procedures that use irradiation include “selective laser sintering” or “selective laser melting”. Thin layers of a most often powdery build material or construction material are here repeatedly layered one on top of the other, and the build material in each layer is selectively solidified via the spatially limited irradiation of locations that correspond to the cross section of the manufacturing product to be fabricated in the respective layer, specifically by partially or completely fusing the powder grains of the build material using the energy locally introduced at this location by the irradiation. After cooling, these powder grains are then bonded with each other in a solid.

As a rule, a component is here manufactured in a construction container, which has a continuous construction container wall and a build platform that can be vertically moved therein. This build platform seals the bottom of the construction container, and thereby forms its floor. A component to be manufactured can be built up on the build platform itself, which then comprises the construction base. To this end, the construction container is initially positioned in the manufacturing device with the build platform raised to the top, and the build platform is moved incrementally downward during the manufacture of a component, so as to in this way place the layers of a construction material on top of each other, and locally solidify them in the desired positions of the construction material.

After the component has been fabricated, not only the component is located in the construction container, but so too is the unsolidified construction material or powder. Upon conclusion of the manufacturing process, the construction container is therefore most often initially transported by means of a handling device, for example a forklift or the like, from the manufacturing device and into an unpacking station, where unsolidified construction material surrounding the component is removed.

Precisely when the build material is metal, the construction container with its contents can be enormously heavy; but even given build material that contains plastic, for example given a construction container with the dimensions 64×47×46 cm (length×width×height), the filled construction container can indeed weigh as much as about 200 kg. For this reason, receiving and transporting a construction container in a position where the fabricated components can be unpacked poses a special challenge.

In a conventional method for unpacking a component located in a construction container, the construction container in a receiving chamber of the unpacking station is pushed up onto rails, wherein the rails grip laterally under a collar on the upper edge of the collar. The rails can be moved from a receiving position, in which the construction container can be received, into an unpacking position, in which the construction container is pressed upwardly against an opening to an unpacking chamber. This movement takes place by means of a swiveling mechanism, which is connected with a bracket. The bracket is here swiveled upward for receiving a construction container, wherein the rails are aligned downwardly inclined. In order to position the construction container in this device, the construction container is initially lifted with the handling device used for transport, in order to then push it at an inclination onto the rail of the bracket with an outer edge, although this can be cumbersome. The bracket is thereupon folded down, during which the rails become horizontally aligned, and the construction container is pressed upwardly from the rails and clamped into the unpacking position. The bracket is folded up and down manually. Given the very high weight of the construction container and its contents, however, it can be very difficult to manually lift the construction container with the bracket.

After the construction container has been clamped by the bracket, a mechanism can be used to move the build platform of the construction container toward the top, so that the conveyed components can be unpacked. This mechanism has an upwardly movable web, which presses against the build platform from below. In order to allow this web to press against the build platform, a corresponding slit is required, which extends from the lower edge toward the top into the construction container wall of the construction container, and increases the manufacturing costs for the construction container.

### SUMMARY OF THE INVENTION

The object of the present invention is to provide an unpacking device of the kind mentioned at the outset that facilitates handling while unpacking a component from a construction container, along with an improved method for controlling such an unpacking device.

This object is achieved by an unpacking device according to the feature combination in claim 1, wherein the subclaims describe at least expedient embodiments and further developments, as well as by a method for controlling an unpacking device according to claim 15.

The unpacking device according to the invention for a construction device of a device for additively fabricating manufacturing products or components comprises at least one receiving chamber, which as described above is used to receive a construction container, for example which incorporates one or several additively fabricated components and the unsolidified construction material that are to be unpacked from the construction container. The construction container “to be emptied” in the receiving chamber here also has a continuous construction container wall (hereinafter also referred to succinctly as “frame”) and a height-adjustable build platform mounted therein.

Just as before, an unpacking chamber is located above the receiving chamber, in which the component(s) received in the receiving chamber can be unpacked from the unsolidified residual construction materials.

A horizontal partition wall is located between the receiving chamber and unpacking chamber. The partition wall prevents the unsolidified powder from getting into the receiving chamber while unpacking the component. However, in order to still be able to unpack the component in the unpacking chamber, the partition wall has a transfer opening or a passage.

In the unpacking device according to the invention, transport of the construction container from the manufacturing device to the unpacking device and transfer can also take place using a handling device such as a forklift or the like.

According to the invention, however, a height-adjustable construction container lifting device is located in the receiving chamber. The latter is designed in such a way as to automatically move a construction container to be emptied and being held in the receiving chamber from a construction container receiving position into a construction container unpacking position. The “construction container receiving position” is here characterized in that a construction container can be received in the receiving chamber in this position.

The construction container lifting device can be used to easily, reliably and uniformly lift the construction containers. In addition, a bracket or the like need not be manually swiveled upward so as to align the very heavy construction containers. Furthermore, a construction container need not be clamped in by an operator in an additional step so as to fix the construction container in its target position.

In addition, the construction container can simply be inserted below into the unpacking chamber of the unpacking device according to the invention, meaning that the construction container need not be further lifted with the handling device for being able to receive it in the unpacking chamber. The construction container is especially preferably designed in such a way as to press from below against the construction container wall of the construction container. The construction container wall thus no longer needs to have a collar on its upper edge.

In addition, the unpacking device according to the invention has a height-adjustable build platform lifting device located in the receiving chamber, which is designed to move a build platform of a construction container received in the receiving chamber from a build platform initial position into a build platform unpacking position. The build platform lifting device here operates parallel to the construction container lifting device, i.e., the two mentioned lifting devices have a parallel path length or lifting direction. The “build platform initial position” is characterized in that the build platform of the construction container can in this position be received by the build platform lifting device, and the build platform rests upon a lower edge of a construction container, meaning is located below in the construction container wall of the construction container. By contrast, a “build platform unpacking position” is characterized in that a component mounted on the build platform and fabricated in a device for additive manufacturing can in this position be unpacked or cleaned in the unpacking chamber, such that the build platform is moved toward the top as required and incrementally within the framework of the construction container during the unpacking process until an end position (“build platform unpacking end position”) of the pathway of the build platform in the construction container has been reached. In this “build platform unpacking end position”, the build platform is located in the uppermost possible position inside of the construction container. Therefore, the build platform initial position and the build platform unpacking positions always relate to the position of the build platform (i.e., the floor of the construction container) relative to the continuous construction container wall of the construction container, wherein there are strictly speaking a plurality of build platform unpacking positions, which start from an initial build platform unpacking position up to the build platform unpacking end position. In the following, each of this plurality of build platform unpacking positions is generically and sweepingly referred to as build platform unpacking position. “As required” here means that, depending on the component geometry, the operator can remove unsolidified build material from the component in portions, in particular manually. The possible, i.e., movable, build platform unpacking positions can basically also continuously adjoin each other.

An additional component of the unpacking device according to the invention is a control device for outputting at least one control signal to the construction container lifting device and build platform lifting device. A shared control signal can basically be output to the construction container lifting device and build platform lifting device. However, respective separate control signals chronologically coordinated with each other can also be output to the construction container lifting device and build platform lifting device. In other words, the control device can communicate with the construction container lifting device and build platform lifting device in such a way that the movements of the construction container lifting device and build platform lifting device take place in the desired way, coordinated and synchronized with each other. Especially preferable time sequences and variants of control signals will be described later.

In the corresponding method according to the invention for controlling an unpacking device, at least the following steps are performed accordingly:

A construction container is initially received in the receiving chamber, for example having previously been conveyed to the unpacking device by a handling device, e.g., a forklift. Control signals or a control signal is/are thereupon output to the construction container lifting device and to the build platform lifting device, so that the construction container located on the construction container lifting device is moved from a construction container receiving position into a construction container unpacking position. The build platform of the construction container is here automatically moved in a time-coordinated manner from a build platform receiving position into a build platform unpacking position by means of the build platform lifting device.

Additional, especially advantageous embodiments and further developments of the invention can be gleaned from the dependent claims and the following description, wherein the independent claims of a claim category can be further developed, analogously to the dependent claims and exemplary embodiments of another claim category, and in particular individual features of different exemplary embodiments or variants can be combined to yield new exemplary embodiments or variants.

As described above, a construction container located in the receiving chamber of the unpacking device can be moved vertically toward the top in the direction of the unpacking chamber, so as to unpack a component. On the other hand, the construction container can also be moved downward again, so as to move the construction container back out of the unpacking chamber once the unsolidified residual construction materials or manufacturing products have been removed. To this end, correspondingly coordinated control signals can be output to the build platform lifting device and the construction container lifting device for lowering the build platform from the build platform unpacking position back into the build platform receiving position of the construction container and for lowering the construction container from a construction container unpacking position into a construction container receiving position.

Whether and when a construction container is moved up or down on a construction container lifting device and the build platform lifting device depends on what a user of the unpacking device according to the invention needs or decides.

To this end, the unpacking device has a user interface, which is coupled with the control device. Depending on when a construction container and when, in coordinated fashion, the build platform of the construction container are to be lifted or depending on the structural design of the unpacking device or user interface, this user interface can then output one or several coordinated lifting control commands or one or several coordinated lowering control commands (so as to lower the build platform of the construction container and, in a coordinated fashion, the construction container) to the control device.

The control device is here preferably designed in such a way as to send a control container lifting control signal to the construction container lifting device given one or several incoming lifting control command(s). This/these incoming control command(s) thus cause(s) the construction container lifting device, and hence a construction container located on the construction container lifting device, to move from the construction container receiving position into the construction container unpacking position. In addition, the control device is preferably configured so that it can send a build platform lifting control signal to the build platform lifting device. This build platform lifting control signal automatically moves the build platform lifting device, and hence the build platform of the construction container, toward the top from the build platform initial position into the build platform unpacking position.

Let it be noted in this conjunction that, in the following, the terms “top” and “bottom”, etc., both in general and within the framework of the present invention, relate to the conventional arrangement in space. In this case, “top” faces in the direction of a ceiling wall of the unpacking device, and “bottom” faces in the direction of a floor of the unpacking device.

The build platform lifting device is here preferably moved in a time delayed manner relative to the construction container lifting device. The time delay makes it possible to ensure that the unsolidified residual construction materials remain in the construction container and cannot trickle out while the latter is being moved and has not yet “docked” with the unpacking chamber. In other words, coordinating the time makes it certain that the build platform in the construction container is only pushed into the frame to an extent and at a speed that prevents the filling in the construction container from spilling over an upper edge of the construction container wall of the construction container (before the construction container lifting device is in the construction container unpacking position of the construction container).

For example, the build platform lifting device can only be moved once the construction container lifting device with a construction container located on the construction container lifting device has reached, or at least reached, the construction container unpacking position. “Essentially” here means that the construction container has reached the construction container unpacking position to the extent that the build platform lifting device is not raised during the remaining travel time of the construction container lifting device to a point where the filling reaches the upper edge of the construction container wall of the construction container. Of course, this depends on the fill level in the construction container. For example, whether the construction container has reached or essentially reached the construction container unpacking position can be checked by way of a limit switch, and then converted accordingly with a 3/2 way valve, for example.

However, a simultaneous start is also possible, as long as this does not cause the build platform in the construction container to move toward the top, meaning if the build platform lifting device moves at most at the same speed as the construction container lifting device, for example, since there is a gap between the build platform and the build platform lifting device when a construction container is in a construction container receiving position.

A structural configuration of the pathways and/or a controlled traveling speed here preferably ensures that—even given a simultaneous start—the build platform lifting device of the build platform of the construction container to be emptied is only reached once the construction container lifting device has reached the construction container unpacking position of the construction container.

If the construction container lifting device and build platform lifting device preferably start simultaneously, this can especially preferably take place with a shared lifting control signal, i.e., the construction container lifting control signal simultaneously corresponds to the build platform lifting control signal, or is used as one, or vice versa. A shared, accompanying lifting control signal is then used to move the construction container lifting device, and hence the construction container located on the construction container lifting device, from the construction container receiving position into the construction container unpacking position, and automatically the build platform lifting device from the build platform initial position into the build platform unpacking position.

The process of outputting control signals to the construction container lifting device and build platform lifting device as well as driving the latter can largely or completely take place controlled by software or electronically and/or electrically, e.g., with electric motors such as a spindle motor. However, the actuation and driving of the construction container lifting device and build platform lifting device can preferably also take place at least in part hydraulically and/or pneumatically. Implementation by means of pneumatic components and/or hydraulic components makes sense especially if the construction container lifting device and build platform lifting device are to be started with a shared control signal. Arranging the hydraulic or pneumatic and mechanical pathways makes it especially easy to coordinate the timing, so that even given a shared start, the build platform lifting device only reaches the build platform of the construction container to be emptied once the construction container lifting device has reached the construction container unpacking position of the construction container.

For example, the advantages to a pneumatic and/or hydraulic drive lie in a continuously variable switching or regulating of the speeds and pathways of the drive. In addition, pneumatic drives require no additional energy when “holding” their position, which in this application is the case while remaining in a build platform unpacking position.

As already mentioned above, the control device can preferably be designed in such a way given a lowering control command or lowering control commands coming in from the user interface as to send a build platform lowering signal to the build platform lifting device, so as to move the build platform of a construction container located on the construction container lifting device from the build platform unpacking position into the build platform initial position by means of the build platform lifting device. Furthermore, the control device can then also send a construction container lowering control signal to the construction container lifting device, preferably delayed in time relative to the build platform lowering control signal, so as to likewise automatically move the construction container back down from the construction container unpacking position into the construction container receiving position again. As mentioned, the construction container lowering control signal and build platform lowering control signal can be one and the same lowering control signal.

It is especially preferred that the control device be designed in such a way that the construction container is only moved away from the construction container unpacking position once the build platform of the construction container has already moved downward a bit in the construction container. This ensures that any residual build material on the build platform initially remains in the construction container, and does not drop laterally into the receiving chamber. For example, a limit switch can be used to check whether the build platform lifting device is all the way down again. It is then also assured that the built platform of the construction container has reached the build platform initial position (inside of the construction container), meaning is once again positioned all the way down in the construction container. Based on this check, it can be ensured that the construction container is only removed from the unpacking device if the build platform lifting device has been moved completely down. Here as well, the construction container lifting device and build platform lifting device could be started simultaneously.

The process of actuating or driving the construction container lifting device and build platform lifting device can here also be implemented strictly based on software or electronically and/or electrically and/or pneumatically and/or hydraulically. Given an at least partial pneumatic and/or hydraulic realization, for example, a position switch or the like can also be used while lowering to ensure that the build platform lifting device starts initially, and the construction container lifting device only starts to be lowered once the build platform lifting device has reached a specific position, e.g., has again reached the build platform initial position.

The user interface coupled with the control device can have one or several control elements. In principle, the control elements can have whatever design desired. For example, they can be designed for manual operation, e.g., as switches or control buttons, wherein these can also take the form of a touch button or the like on a touch display. Another possibility involves control elements for recognizing gestures of the user as control commands. For example, these include a camera and gesture recognition module. Control elements for recognizing user gestures are here also to be understood as manual control elements to the extent that they are intended to interpret the gesture of one or both hands of the user as control commands. However, the control elements can exemplarily also be designed for receiving voice commands, e.g., taking the form of a microphone and voice recognition module. In particular, a user interface can also comprise a combination of different control elements.

The user interface along with the control device can preferably be designed in such a way that a construction container lifting control signal and/or a build platform lifting control signal is only output given the synchronized actuations of at least two spatially separated control interfaces of the user interface.

To this end, the user interface preferably has at least three control interfaces or control elements, so as to output one or several lifting control commands to the control device when simultaneously operating or using a first control element and a second control element.

In the case of manual control elements, such as switches, etc., a lowering control command can be output to the control device when operating or using a third control element.

For example, the condition of synchronized control interface actuation or verification of this condition as to whether all lifting control commands are simultaneously present can take place with a safety circuit, e.g., with AND gates. This safety circuit or part of this safety circuit can be integrated before the control device. As a result, the user interface, as already mentioned, can output one or several lifting control commands to the control device if the aforementioned condition has been satisfied. However, the condition can also be verified completely only in the control device, as will be explained in more detail later.

The control device is especially preferably designed in such a way as to output a construction container lifting control signal and/or a build platform lifting control signal only during simultaneous actuation with both hands. This can be realized via the inspection described above, which verifies that a construction container lifting control signal and/or a build platform lifting control signal is output only given synchronized—specifically in this case simultaneous-actuations of at least two spatially separated control interfaces of the user interface. However, it can also be required that the user use both hands to formulate the (visual) control command for gesture recognition.

When a user must unavoidably automatically use both hands to trigger a construction container lifting control signal and/or a build platform lifting control signal, this constitutes an additional safety aspect of the unpacking device, since it can in this way be ensured that the user has removed both hands from the traversing range, and thus cannot get them jammed in the unpacking device.

Voice actuation also makes it possible to achieve a corresponding level of safety where the hands are not located on the device if it is ensured that the user must enunciate the commands at a sufficient distance from the unpacking device for them to be recognized and/or accepted.

The unpacking chamber of the unpacking device preferably has a cover. If the cover is sealed, e.g., which can be verified by means of a sensor, this can be correspondingly signaled to the control device. It is then preferable to send a construction container lifting signal to a construction container and a build platform lifting control signal to the build platform only if the control interfaces are selected in a synchronized manner, i.e., if all lifting control commands are simultaneously present, and the cover is also sealed. Furthermore, this can reduce the danger of a user or operator or another adjacent person jamming a finger, etc. in the unpacking chamber.

In addition, a cover makes it possible to greatly reduce or even entirely avoid the exposure of the operator to powder dust. To allow a user to unpack a component despite a sealed cover, the cover preferably has an engagement area through which the user can reach so as to clean a component in an unpacking area of the unpacking chamber. The engagement area especially preferably comprises lamellae through which a user reaches when wishing to unpack a component. The lamellae can likewise ensure that only relatively little and possibly no powder gets outside of the unpacking device. For example, they can brush any residual powder from the hands of a user during the unpacking process when the latter removes his or her hands from the unpacking chamber. In order to observe and verify the unpacking process with the cover sealed, for example, the cover preferably has a viewing window.

There are various options for specifically constructing the construction container lifting device and the build platform lifting device.

The construction container lifting device preferably comprises at least two, especially preferably at least four, lifting cylinders, for example hydraulic stamps or pneumatic stamps. A lifting cylinder here preferably has a cylinder housing and an upwardly extendable piston movably mounted therein. The pistons can preferably be arranged in such a way as to press against the construction container wall of the construction container from below, e.g., against two opposing sides, especially preferably in all four corner areas simultaneously. The advantage to such a construction of the construction platform lifting device with lifting cylinders pressing laterally or in the corner areas against the frame under a construction container is that the middle, central area under the construction container remains free for the build platform lifting device.

Accordingly, the build platform lifting device is preferably designed in such a way that it can act from below on the build platform or the floor of the construction container, e.g., so as to push the floor in the frame toward the top after a preceding build platform lifting control signal. This eliminates the need for any extra configuration of the construction container wall of the construction container, for example incorporating a slit or the like, so that the build platform can be gripped by the build platform lifting device. The build platform lifting device preferably comprises at least one lifting table, especially preferably a scissors lift.

As already mentioned, it is advantageous that no unsolidified residual construction materials get into the receiving chamber while the construction container is being moved toward the top into the construction container unpacking position. In order to realize this, the transfer opening can be configured in various ways.

One option involves preferably designing the transfer opening in the partition wall between the receiving chamber and unpacking chamber in such a way that, when the construction container or the construction container lifting device is located in the construction container unpacking position, the outer upper edge of the construction container wall of the respective construction container adjacent to the partition wall indirectly or directly (as viewed from the receiving chamber) encircles or encases the entire transfer opening or passage, or seals the transfer opening against the receiving chamber. The construction container wall here impacts the partition wall from below.

The periphery of the transfer opening is here especially preferably larger than or identical to an inner periphery of a defined inner frame dimension of the continuous construction container wall of a construction container to be received (i.e., the unpacking device being provided for receiving the latter), and the periphery of the transfer opening is smaller than an outer periphery of a defined outer frame dimension of the continuous construction container wall of a construction container to be received, wherein the contours of the edges of the construction container wall and the opening of the construction container are aligned essentially parallel to each other. The transfer opening thus especially preferably lies within a boundary prescribed by the outer and inner edge of the construction container wall of the construction container. Within the framework of the present invention, a “defined” or prescribed construction container dimension or inner frame dimension or outer frame dimension is correspondingly to be understood as a respective normed or standard measure for the construction containers to be used or unpacked in the unpacking device.

In particular, the smallest side length of the transfer opening is larger than or identical to a smallest inner side length of a defined inner frame dimension (viewed from an outer upper edge of the construction container wall), and a maximum side length of the transfer opening is larger than or identical to a maximum inner side length of a defined inner frame dimension (viewed from the outer upper edge of the construction container wall). A smallest side length of the transfer opening is also smaller than a smallest outer side length of a defined outer frame dimension (viewed from the outer upper edge of the construction container wall), and a maximum side length of the transfer opening is smaller than a maximum outer side length of a defined inner frame dimension (viewed from the outer upper edge of the construction container wall). This prevents the transfer opening from protruding into the clearance of the construction container, and unsolidified residual construction materials from being pressed into an overlapping area of the partition wall and build platform, which can then only be removed again with difficulty.

In a preferred embodiment of the transfer opening, the latter is configured in such a way that a construction container wall of a construction container can move precisely into the transfer opening when the construction container is moved into the construction container unpacking position. The transfer opening is here designed in such a way as to completely enclose the side walls of a construction container wall of the construction container adjacent to the partition wall when it is in the construction container unpacking position. Outer side walls of the continuous construction container wall moved into the transfer opening are here completely enclosed by the transfer opening.

If the construction container is in the construction container unpacking position, the upper edge of the construction container and an upper side of the partition wall preferably lie at one height or plane, i.e., are aligned flush with each other.

The introduced construction container wall preferably tapers toward the top or has a conical design at its upper end, i.e., pointing toward its upper edge. The slopes at the upper edges of the construction container wall converge toward the top to form the conical shape.

Below the partition wall, the unpacking device preferably has an insertion aid or insertion rail, which serves to precisely align the construction container while it is being moved toward the top. To this end, the insertion rail is preferably beveled at a lower edge pointing toward the construction container wall, i.e., the insertion aid there has a downwardly expanding conical shape, which interacts with the configuration of the construction container wall that conically converges toward the top.

In order to be able to pick up and collect loose, i.e., unsolidified, residual construction material after cleaning the component, the unpacking device preferably has a residual powder chamber. The latter is especially preferably likewise located under the unpacking chamber. The residual powder chamber is preferably located next to the receiving chamber.

The residual powder chamber preferably has a rollable, displaceable powder receiving box. The powder collected in the powder receiving box can then again be prepared and returned to the additive manufacturing process, for example. Alternatively or additionally, however, the residual powder chamber can itself be equipped with a powder removal device. The powder removal device can here preferably comprise a powder pump, with which the preferably sieved powder can be transported in an external box for powder reprocessing.

The unpacking chamber is preferably connected with the residual powder chamber by a sieving device.

For example, the sieving device can preferably comprise a sieving area in the partition wall or below the partition wall between the unpacking chamber and residual powder chamber. The sieving device can especially preferably also be multistage. For example, it can consist of a coarse sieve in the partition wall and a fine sieve below the partition wall or below the coarse sieve. The sieving device preferably is located above the receiving box or a port of a powder removal device. The unsolidified residual construction material can then get from the unpacking chamber into the residual powder chamber through this sieving area. For example, the sieving device can be used to separate larger chunks of the residual construction material from the still usable powder, which can correspond to a construction material reprocessing step. Above all, the sieving device makes it possible to ensure that no small components are removed with the powder.

Alternatively or additionally, the sieving unit can then be connected directly to a powder removal device. A powder pump could here convey the sieved powder directly into a box of a manufacturing device, which would eliminate the need for a powder receiving box.

While unpacking the component in the unpacking chamber, swirling powder dust comprised of the unsolidified fine residual construction material may be encountered. In order to prevent the powder dust from placing an excessive burden on the operator, for example, and remove the powder dust right away, the unpacking device preferably has a vacuuming device. As a result, excess powder dust is vacuumed out of the unpacking chamber, while the main portion of the unsolidified residual construction material is preferably removed via the sieving device.

This vacuuming device preferably has vacuuming openings, especially preferably above an unpacking area, meaning in particular above the build platform lifting device in the build platform unpacking position.

In order to be able to vacuum up the powder dust right where it is kicked up, the vacuuming device preferably has a plurality of vacuuming openings, meaning at least two vacuuming openings, at locations spatially separated from each other. The vacuuming device especially preferably has a plurality of vacuuming openings, for example preferably at least five, especially preferably ten, very especially preferably at least twenty. In order to vacuum away the dust in the largest possible area in the unpacking chamber, the vacuuming openings are preferably distributed along a primary extension direction of the unpacking device inside of the unpacking device; they are especially preferably distributed essentially along the complete length in the primary extension direction inside the unpacking device. In order to also uniformly vacuum away the powder dust in the space of the unpacking chamber, the vacuuming openings are preferably distributed and arranged spaced apart in essentially the same intervals. The primary extension direction of the unpacking chamber is to be understood as the direction of the longest expansion of the unpacking chamber, here meaning preferably the direction in which the unpacking chamber extends from the area over the receiving chamber into the area above the residual powder chamber.

In order to provide another protective mechanism for a user of the unpacking device, the receiving chamber can preferably comprise a lockable loading opening, through which the construction container can be transferred into the receiving chamber. The loading opening preferably has one or several doors. If a construction container has been positioned in the receiving chamber, the doors can be closed once again. As a result, for example, a user cannot reach into the receiving chamber while a construction container is being lowered or moved down.

In order to check whether the doors are closed, the doors can have sensors connected electronically and/or pneumatically and/or hydraulically with the control device. It is then preferable to first send a construction container lifting control signal to a construction container and a build platform lifting control signal to the build platform when selecting the control interfaces in a synchronized manner, meaning when all lifting control commands are simultaneously present, and the doors are also closed. Furthermore, this can reduce the danger of a user or operator or another adjacent person jamming a finger, etc. in the unpacking chamber.

The different lifting processes and/or lowering processes for the construction container can preferably be stopped at any time by no longer activating a control element required for the lifting process and/or lowering process and/or when a sensor signal scanned for safety purposes is (suddenly) no longer present, for example from a sensor for checking the closed doors and/or checking a closed cover.

In order to reduce the risk that a construction container located on a construction container lifting device becomes tilted while moving, and thus ensure that the construction container is also aligned as precisely as possible to the transfer opening in the partition wall to the unpacking chamber, the unpacking chamber preferably has centering elements or spacers, so as to precisely position a construction container received in the receiving chamber on the construction container lifting device. The centering elements are preferably located on the doors and the (side and rear) inner walls of the receiving chamber.

### BRIEF DESCRIPTION OF THE DRAWINGS

The invention will be described once more in greater detail below with reference to the attached figures based upon exemplary embodiments. The same components on the various figures are provided with identical reference numbers. As a rule, the figures are not to scale. Respectively shown schematically on:

FIG. 1 is an illustration of a front view of an unpacking device according to the invention;

FIG. 2 is a front view with partial sections through the unpacking device according to FIG. 1 with an open cover and open doors of the receiving chamber and residual powder chamber, and with a section through a construction container, wherein the construction container lifting device is in a construction container receiving position, and the build platform lifting device is in a build platform initial position;

FIG. 3 is the unpacking device according to FIGS. 1 and 2 with open cover and open doors of the receiving chamber, wherein the construction container lifting device is in a construction container unpacking position, and the build platform lifting device is in a build platform unpacking end position;

FIG. 4 is a magnified partial sectional view of the construction container in the construction container unpacking position according to FIG. 3;

FIG. 5 is a top view of a partition wall of an unpacking device;

FIG. 6 is a rough schematic view of a block diagram for a first embodiment of a safety circuit;

FIG. 7 is a rough schematic view of a block diagram for another embodiment of a safety circuit.

### DETAILED DESCRIPTION OF THE EMBODIMENTS

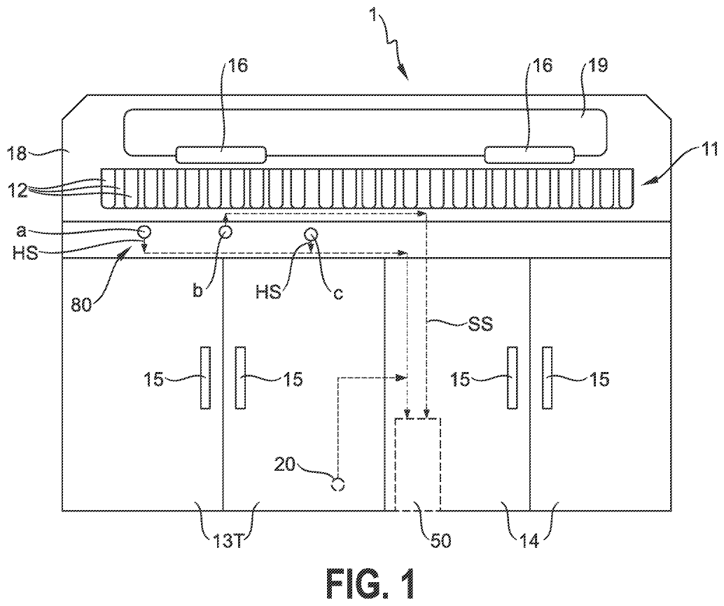

FIGS. 1, 2 and 3 will be described together below, since they show the same exemplary embodiment of an unpacking device 1 according to the invention, but in different operating states.

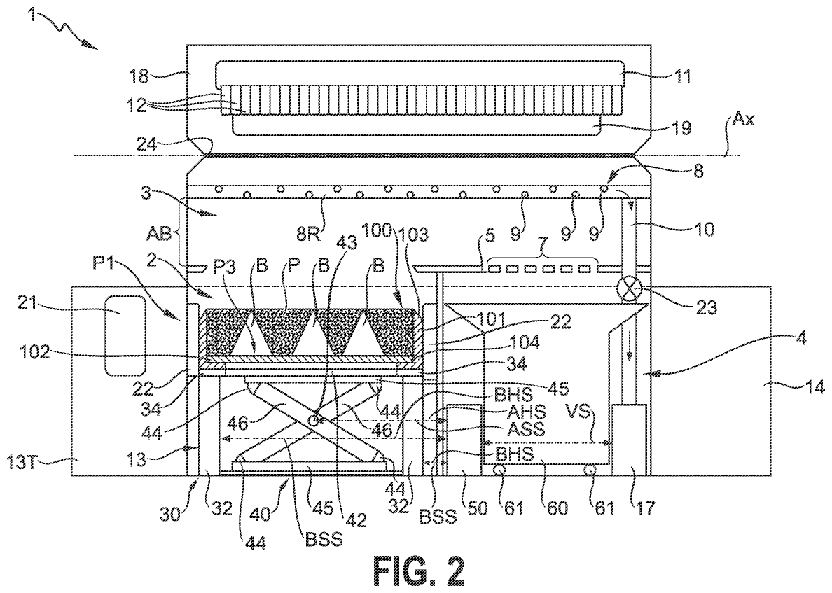

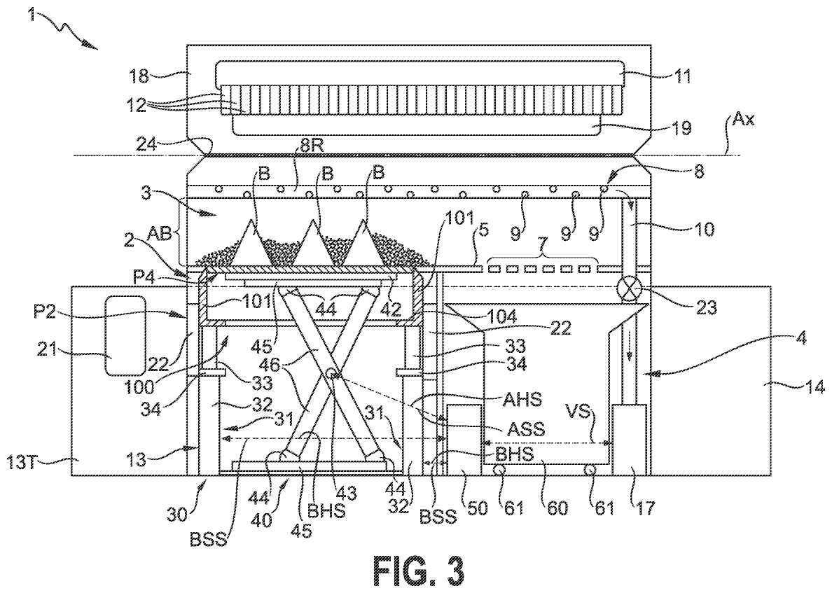

As evident from FIGS. 2 and 3, the unpacking device 1 has a receiving chamber 2 (on the respective bottom left of the figures), into which can be transferred one or several components B to be cleaned in a construction container 100 (also referred to as an “interchangeable frame”).

The essentially rectangular construction container 100 in a top view has a continuous construction container wall 101, whose cross section resembles a kind of L-profile. The short leg of this L-profile of the construction container wall 101 is located at the lower end of the construction container wall 101, and extends inwardly to form a continuous collar. A build platform 102 that can move in the construction container wall 101 lies on the short leg of the construction container wall 101 or the collar at the top, which hence forms a height-displaceable floor of the construction container 100. This area or collar upon which lies the build platform 102 is also referred to below as the lower edge 104 of the construction container 100. On this build platform 102, the components were built up in the manufacturing device in an additive manufacturing process, wherein powdery build material P (hereinafter also referred to as powder P) was applied in layers and selectively solidified while incrementally lowering the build platform 102. The construction container 100 is thus filled with powder at least up to the upper end of the highest component B. This powder P must be removed in order to unpack the components B.

To this end, the unpacking device 1 has an unpacking chamber 3 located above the receiving chamber 2, in which the components B received in the receiving chamber 2 can be unpacked.

This unpacking chamber 3 here has a cover 18, which is connected by way of a hinge 24 with an upper edge of the frame of the unpacking chamber 3. Handles 16 can be used to upwardly swivel and open the cover 18 around its swivel axis Ax along the hinge 24, and swivel it back down and close it again.

Located below the unpacking chamber 3 and next to the receiving chamber 2 is a residual powder chamber 4, in which the unsolidified residual construction material P or the powder removed from the components B are accumulated. The receiving chamber 2 and residual powder chamber 4 are separated from the unpacking chamber 3 by a horizontal partition wall 5, which essentially extends over the entire inner length or primary extension of the unpacking device 1.

For example, due to its potentially very high weight, a construction container 100 can be transferred by means of a handling device (not shown here) or lifting device, e.g., a forklift, to the unpacking device 1. To this end, the front of the receiving chamber 2 has a lockable loading opening 13, with doors 13T and handles 15 (see FIG. 1). In order to here be able to easily and precisely position the construction container 100, the receiving chamber 2 has centering elements 21 on the interior sides of the doors 13T and centering elements 22 on the inner lateral walls of the unpacking device to the side and rear (not shown here). While being pushed in, the construction container 100 is thus initially centered laterally by the centering elements 22, which are located on the inner, lateral walls of the receiving chamber 22. The construction container 100 is thereupon centered toward the rear by the centering elements 22, which are located on the inner, rear walls of the receiving chamber 2. While closing the doors 13T, the construction container 100 is finally centered toward the front by the centering elements 21. The centering elements can here be made out of hard plastic cushions or the like, for example.

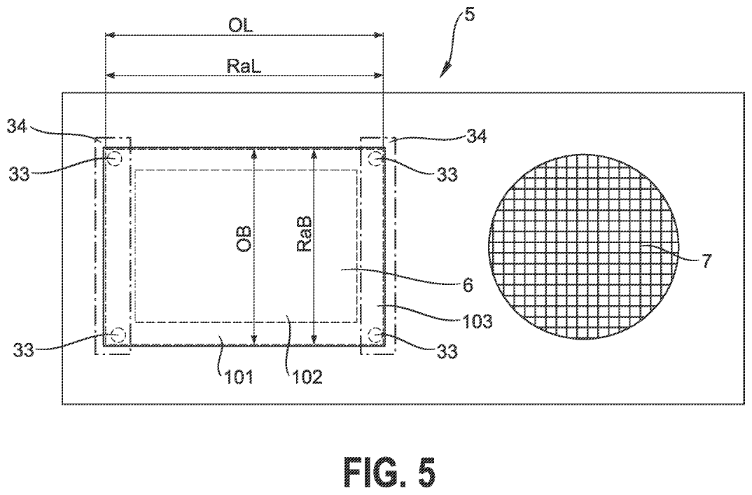

A construction container 100 transferred to the receiving chamber 2 is carried by a height-adjustable construction container lifting device 30 in the receiving chamber 2. This construction container lifting device 30 comprises several lifting cylinders 31, here specifically four hydraulic stamps 31 (only the two front lifting cylinders are visible on FIGS. 2 and 3 given the frontal view, while all four lifting cylinders are symbolized on FIG. 5), on which the construction container 100 rests with its four corner areas. A hydraulic stamp 31 here has a cylinder housing 32 and a height-adjustable piston 33 therein (which also could be multistage). In the position in which the construction container 100 is received, the construction container lifting device 30 is in a construction container receiving position P1, as shown on FIG. 2. On FIG. 2, the build platform lifting device 40 is also in a build platform initial position P3, in which it essentially is arranged in one plane with the upper support surfaces 34 of the lifting cylinder 31 of the construction container lifting device 30, and thus does not yet come into direct contact with the build platform 102.

The build platform lifting device 40 here comprises a lifting table 41 with a scissors lift having two levers or legs 46 hinged together on a scissor axis 43. The ends of the legs 46 have bearing bolts 44, which can be pushed into a sliding rail 45. Two of the bearing bolts 44, in this case the top right and bottom right ones, can here be immobilized (fixed bearings), so that only the respective horizontally opposing bearing bolts 44 can be displaced (floating bearing). Located on the upper sliding rail 45 is a support plate 42, on which the build platform 102 rests. However, the build platform lifting device 40 can also comprise additional scissors lifts for purposes of load distribution. The scissors lifts are then preferably arranged parallel to each other, have the same (virtual) swivel axis, and can be moved in parallel. Due to their arrangement, however, only one scissors lift would be discernible on FIGS. 2 and 3, since additional scissors lifts would be covered by a first scissors lift.

If the construction container 100 is now to be moved toward the top, the doors 13T and cover 18 will be closed, as shown on FIG. 1.

Horizontally at the front of the housing of the unpacking device 1, an area on which the user interface 80 is arranged (only delineated on FIG. 1) extends between the cover 18 and the doors 13T of the receiving chamber 2 and the doors 14 of the residual powder chamber 4. This user interface 80 here comprises three control interfaces or control elements a, b, c in the form of pushbuttons a, b, c.

If the two outer pushbuttons a, c are activated and the doors 13T are closed, lifting control commands HS are sent to a control device 50, which is depicted only with a dashed line on FIG. 1, since it is located inside the housing of the unpacking device 1. In order to determine whether the doors 13T are closed, the doors 13T each have a sensor 20 (of which only one is shown here), which is electrically and/or hydraulically and/or pneumatically connected with the control device 50.

If the control device 50 receives the required lifting control commands HS, it sends a control signal BHS or construction container lifting control signal BHS to the construction container lifting device 30. The control signal BHS causes the construction container 100 located on the construction container lifting device 30 to move from the construction container receiving position P1 into a construction container unpacking position P2.

If the construction container 100 is then in the construction container unpacking position P2, an outer upper edge 103 of the continuous construction container wall 101 lies on one plane with an upper side of the partition wall 5, as visible on FIG. 3. This is realized by a correspondingly adjusted height setting of the lifting cylinder 31.

The construction container wall 101 is here upwardly tapered or conically shaped, i.e., in the direction of its upper edge 103. The outer upper edges (in the direction of the upper edge 103) of the construction container wall 101 are here beveled.

The build platform 102 is then moved into the build platform unpacking end position P4, meaning essentially so far toward the top that a support surface on which components B to be unpacked are resting is likewise flush with an upper edge of the partition wall 5, or to a point where a user can unpack the components B. The build platform 102 here lies centrally in a transfer opening 6 of the partition wall 5.

In this regard, FIG. 5 shows a top view of the partition wall 5, with a sieving area 7 above the residual powder chamber 4 (see also sectional view on FIGS. 2 and 3), here specifically a circular sieve 7 on the right side and the transfer opening 6 to the receiving chamber 2 on the left side. The build platform 102 is here located directly in the transfer opening 6.

The continuous construction container wall 101 was here denoted by dashed lines, and the pistons 33 of the construction container lifting device 30 were denoted by dotted circles. As on FIGS. 1 and 2, the shorter frame borders of the construction container wall 101 on the left and right here rest on the construction container lifting device 30 at the respective corners.

In addition, the two support surfaces 34 or support rails 34 that run in parallel along the short sides of the construction container are here denoted by the dot-dashed lines, which interconnect the respective cylinder housing 32 of the two hydraulic stamps 31 on a short side of the construction container 100 on its upper edge, and thereby additionally ensure the stability of the construction container lifting device 30. The construction container 100 can easily be pushed onto these support rails 34 for transfer into the unpacking device 1. In this position, the upper side of the support plate 42 of the lifting table 41 is aligned flush with the support rails 34, i.e., a short distance below the build platform 102. While traveling upward, the construction container 100 is then automatically carried at the corners by the four pistons 33 of the hydraulic stamp 31, which each extend through the support rails.

In the construction container unpacking position P2, the construction container 100 has moved into the transfer opening 6 as mentioned, and the upper edge 103 of the construction container wall 102 here becomes flush with the upper side of the partition wall 5. The dimensions of the transfer opening 6 are here selected in such a way as to be adjusted to the (prescribed) dimensions of the construction container wall 101 of a construction container 100 to be received.

A maximum side length OL of the transfer opening 6 is here essentially (to include fitting tolerances) as large as a maximum outer side length RaL of a defined outer frame dimension, viewed from the upper edge 103 of the continuous construction container wall 101. The smallest side length OB of the transfer opening 6 is here essentially (to include fitting tolerances) as large as a smallest outer side length RaB of a defined outer frame dimension, viewed from the upper edge 103 of the continuous construction container wall 101. These dimensions allow the construction container 100 to be moved into the transfer opening 6, wherein an upper section of the outer side walls of the construction container wall 101 is completely encased by the partition wall 5. As a result, no powder P can fall out of the construction container 100 into the receiving chamber 2 by way of the construction container wall 101.

If the construction container 100 is filled up to the outer upper edge 103 of the construction container wall 101, as depicted on FIGS. 2 and 3, it is especially advantageous that the outer dimensions of the construction container wall 101 correspond to those of the transfer opening 6, and that the construction container 100 (as described above) move into the transfer opening 6 of the partition wall 5. This also prevents any powder P from possibly lying on the outer upper edge 103 of the upper construction container wall 101 and being pressed between the outer upper edge 103 and partition wall 5.

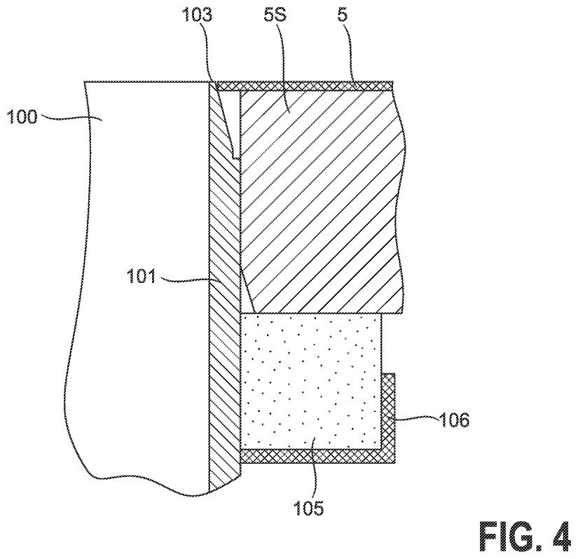

In order to be able to insert the construction container 100 into the transfer opening 6 of the partition wall 5 as easily as possible, the construction container wall 101 of the construction container 100 is upwardly tapered or conically shaped, as mentioned already. In other words, an upper outer edge of the construction container wall 101 is here beveled, as visible in the section on FIG. 4. In addition, the unpacking device 1 here has an insertion rail 5S located below the partition wall 5 (not shown on FIGS. 2 and 3 for better clarity). This insertion rail 5S can be used to additional center the construction container 100, so as to make it simpler or easier to precisely move the construction container wall 101 into the transfer opening 6. To this end, a lower edge pointing toward the construction container wall 101 is beveled, i.e., the insertion rail 5S has a conical shape that matches the conical configuration of the construction container upper edge.

A gasket 105 that runs around the construction container wall 101 here provides additional assurance that no unsolidified construction material or powder dust can get into the receiving chamber 2 of the unpacking device 1 (apart from aligning the construction container 100 in the transfer opening 6 while in the construction container unpacking position P2 and coordinating the movement of the construction container wall 101 and build platform 102). If the construction container wall 101 is in the construction container unpacking position P2 of the construction container 100, an upper side of the gasket 105 impacts a lower side of the insertion rail 5S. For example, the gasket 105 can here be fixed on the external sides of the construction container wall 101, e.g., adhesively bonded. It is here provided with additional stability (see FIG. 4) by an upwardly open, roughly rectangular holding frame 106 extending outwardly from the external sides of the construction container wall 101, which outwardly runs annularly around the construction container wall 101 and is secured thereto, wherein the gasket 105 lies in this holding fame 106. In order to achieve an optimal and uniform sealing, the gasket can be resiliently pressed against the insertion rail 5S.

If the construction container lifting device 30 has arrived at the construction container unpacking position P2, the control device 50 here sends a control signal AHS, or a build platform lifting control signal AHS, to the build platform lifting device 40. Whether the construction container lifting device 30 has reached the construction container unpacking position P2 can be checked by way of a limit switch (not sketched in here). The AHS control signal then moves the build platform 102 of the construction container 100 from the build platform receiving position P3 into a build platform unpacking end position P4 by means of the build platform lifting device 40 in a time coordinated manner. If the construction container lifting device 30 is in a construction container unpacking position P2 and the build platform lifting device 40 is in the build platform unpacking end position P4, the components B to be cleaned on the build platform 102 lie in an unpacking area AB of the unpacking chamber 3, as shown on FIG. 3.

However, the construction container lifting device 30 and build platform lifting device 40 can also be moved in a time coordinated manner by means of a shared control signal, as will be explained in even more detail later.

In order to allow a user to unpack and clean a component B without opening the cover 18, the cover 18 here has an engagement area 11 with lamellae 12, through which the user can reach. The lamellae largely hold back the powder P and powder dust from the unpacking chamber 3 during the unpacking process. If the user removes his or her hands through the engagement protector 11, the lamellae 12 can additionally brush the powder

P from the hands. In order to allow a user to look into the unpacking chamber 3, the cover 18 here has a window 19.

The unpacking process most often causes powder dust to be kicked up. This arising powder dust can be removed by means of a vacuuming device 8. The vacuuming device 8 has a suction tube 8R above the unpacking area AB, which extends horizontally over essentially an entire length of the unpacking chamber 3. The powder dust can thus be sucked in through a plurality, here specifically twenty, vacuuming openings 9 in the suction tube 8R. The vacuuming openings 9 are here distributed largely uniformly along the longitudinal or primary extension of the vacuuming device 8. In the example depicted, the powder dust is aspirated via a pump 17 of the unpacking device 1, which is connected by a line 10 with the suction tube 8R of the vacuuming device 8. The pump 17 is also electrically connected with the control device 50, and can be actuated by the latter by a pump control signal VS. Alternatively, vacuuming can also take place via an external suction port, e.g., a vacuum cleaner or a household vacuuming system (not shown).

The unpacking device 1 could alternatively or additionally also have one or more flexible suction trunks in the unpacking chamber 3 for vacuuming up powder, for example.

The majority of the unsolidified residual construction material P is conveyed via the sieve 7 in the partition wall 5 down into the residual powder chamber 4. If needed, the sieve 7 can be taken out of the partition wall 5, for example so that it can be changed out or cleaned. In the residual powder chamber 4, the unsolidified residual construction material P is here captured and accumulated in a powder receiving box 60 located below the sieve 7. The powder P vacuumed up with the vacuuming device 8 can likewise be deposited into the powder receiving box 60. The vacuumed up powder P is here separated from the likewise vacuumed air by a separator 23 in the line 10, and fed to the powder receiving box 60.

Once the powder receiving box 60 has reached a defined fill level, the doors 14 of the residual powder chamber 4 can be opened, and the powder receiving box 60 here provided with rollers 61 can be rolled out of the residual powder chamber 4. For example, the powder receiving box 60 can then be moved to a device for additively manufacturing components B. If needed, the powder P can there be further processed and fed to a powder chamber. In this way, the powder P can then easily be reused for a new construction job. However, a conveying process can alternatively also be used for powder removal, wherein use is made of a powder pump that conveys the sieved powder P directly into a box for a manufacturing device.

The unpacked component B can then be removed from the unpacking chamber 3. Alternatively, however, the component B can again also be lowered into the otherwise empty construction container 100, and removed from the receiving chamber 2 with the construction container 100. To this end, a user actuates the third control element b, which sends a lowering control command SS to the control device 50. Upon receiving the lowering control command SS, the control device 50 in turn sends a build platform lowering control signal ASS to the build platform lifting device 40, so as to move the build platform 102 of a construction container 100 located on the construction container lifting device 30 from the build platform unpacking position P4 into the build platform initial position P3 by means of the build platform lifting device 40. If the build platform 102 is once again in the build platform initial position P3, the control device 50 sends a construction container lowering control signal BSS to the construction container lifting device 30, so as to automatically move the construction container 100 from the construction container unpacking position P2 back into the construction container receiving position P1.

Here as well, the construction container lifting device 30 and build platform lifting device 40 could be moved into the construction container receiving position P1 of a construction container 100 or into the build platform initial position P3 in a time coordinated manner by means of just a single, shared lowering control signal, as will be described in even greater detail later.

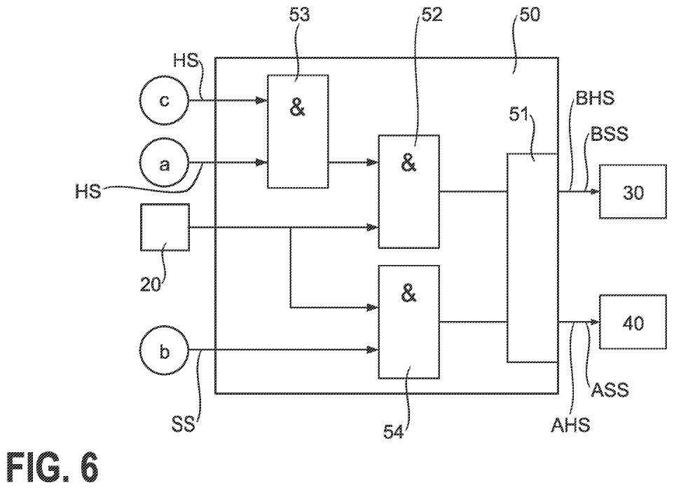

FIG. 6 presents a block diagram showing a simple circuit (here realized in the control device 50), with which a construction container lifting control signal BHS can be transmitted to the construction container lifting device 30, and a build platform lifting control signal AHS to the build platform lifting device 40, wherein required conditions, specifically the simultaneous activation of two spatially separated pushbuttons a, c and the closing of doors 13T must automatically be met, and with which a construction container lowering control signal BSS can be transmitted to the construction container lifting device 30, and a build platform lowering control signal ASS to the build platform lifting device 40.

As a first condition for transmitting a construction container lifting control signal BHS to the construction container lifting device 30 and a build platform lifting control signal AHS to the build platform lifting device 40, the first control element a and the second control element c spatially separated from the latter are activated at the same time, and send out their respective lifting control command HS. This state can be illustrated or realized by an AND gate 53 as a link between both input signals in the control device 50. If both control elements a, c are pressed, meaning both lifting control commands HS are generated simultaneously, the state is “true” or “accurate”. A 1 is then present at both inputs of the AND gate 53, which also delivers a 1 at the output of the AND gate 53. If neither or just one of the control elements a, c is pressed, only one input of the link or even no input of the link assumes the value 1. As a consequence, the output also does not assume the value 1.

Another condition for transmitting a construction container lifting control signal BHS to the construction container lifting device 30 and a build platform lifting control signal AHS to the build platform lifting device 40 is here that the doors 13 of the unpacking device 1 be closed. As already mentioned, the doors 13T have a sensor to verify this, for example here a pneumatic key, the state of which is acquired by an input of another AND gate 52, whose other input is connected to the output of the first AND gate 53. If the first control element a and the second control element c are activated at the same time, and the doors 13T are closed, the initial state of the additional AND gate 52 is here also regarded as “true” or “accurate”. This means that the output of the AND gate 53 assumes a 1, and hence one input of the circuit of the AND gate 52 assumes the value 1, and the second input the value 1, since the doors 13T are closed. In this way, the circuit of the AND gate 52 delivers a 1 at its output. If one of the two first and spatially separated control elements a, c were not to be activated simultaneously, meaning if all required lifting control commands HS are not present simultaneously, or the doors 13T were not closed, the circuit of the AND gate 52 would deliver a 0.

In addition, the control device 50 has a third AND gate 54, which is electronically connected with the third control element b and with the sensor 20 of the doors 13T. As already mentioned, the control element b can be activated if the construction container lifting device 30 and the build platform lifting device 40 are to be lowered. In this way, then, a construction container lowering control signal BSS is transmitted to the construction container lifting device 30 and a build platform lowering control signal ASS to the build platform lifting device 40 only if the doors 13T of the unpacking device 1 are closed. This can be verified by means of the third AND gate 54. If the third control element b is activated and the doors 13T are closed, the state is here also regarded as “true” or “accurate”. This means that one input of the AND gate 54 assumes the value 1, and the second input the value 1, since the doors 13T are closed. In this way, the link of the AND gate 54 delivers a 1 at its output.

In an evaluation device 51 of the control device 50, the incoming signals are then detected, checked and correspondingly converted. Thereafter, either no signal is transmitted to the construction container lifting device 30 and the build platform lifting device 40, and a construction container lifting control signal BHS is transmitted to the construction container lifting device 30 and a build platform lifting control signal AHS to the build platform lifting device 40 in a time-coordinated, e.g., chronologically fitting, manner, or a construction container lowering control signal BSS is transmitted to the construction container lifting device 30 and a build platform lowering control signal ASS to the build platform lifting device 40. For example, these signals can be electrical signals, which actuate corresponding electric motors.

The actuation of the build platform lifting device 40 and construction container lifting device 30 described above predominantly takes place electronically or electrically. To a large extent, it can also be realized with software, for example by realizing the gates via corresponding queries in software modules.

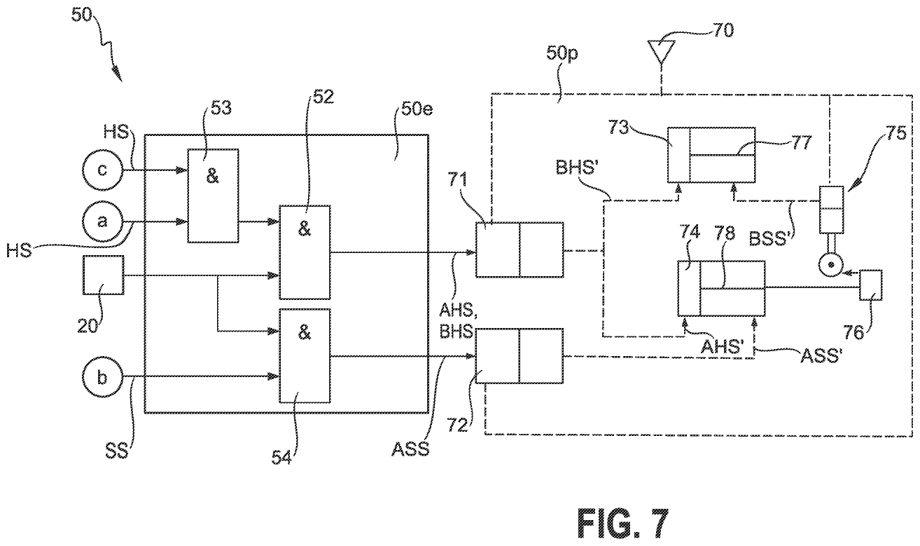

In another preferred embodiment of a control device 50 shown in a rough schematic on FIG. 7, the build platform lifting device 40 and construction container lifting device 30 are actuated or driven not only by software or electrically or electronically, but to a large extent also by pneumatic control elements. To this end, the control device 50 has an electrical or electronic part 50e and a pneumatic part 50p. However, let it be explicitly noted that additional control parts, i.e., including the electrical or electronic part 50e depicted on FIG. 7, and thus in particular the entire control device, can basically also be realized by pneumatic and/or hydraulic components.

With the exception of the evaluation device 51, the electrical or electronic part 50e of the control device 50 on FIG. 7 essentially corresponds to the control device 50 from FIG. 6. Therefore, if the first control element a and the second control element c are activated at the same time and the doors 13T are closed, for example, the AND gate 52 delivers a 1 at its output, as already described. As a result, a construction container lifting control signal BHS is sent to the construction container lifting device 30, and a build platform lifting control signal AHS to the build platform lifting device 40, wherein the construction container lifting control signal BHS and build platform lifting control signal AHS are not two different lifting control signals, but rather a single, shared lifting control signal.

This lifting control signal AHS, BHS is here sent to a first way valve 71 connected with the electronic or electrical part 50e of the control device 50. This first way valve 71, preferably a 2/2-way valve 71, is connected with a compressed air source 70, and converts the electronic lifting control signal AHS, BHS into a pneumatic lifting control signal AHS′, BHS′.

Let it be noted at this juncture that corresponding hydraulic components operated with a hydraulic fluid can also be used in place of pneumatic components with compressed air or the like. However, a pneumatic design will continue to serve as an example below, without loss of generality.

If the way valve 71 now receives the lifting control signal AHS, BHS, this valve 71 opens up the path for the compressed air (wherein the compressed air lines on FIG. 7 are denoted by dashed lines) opened to it by the compressed air source 70. This compressed air simultaneously extends a piston 77 of a cylinder 73, preferably a dual-action cylinder 73, of the construction container lifting device 30 and a piston 78 of a cylinder 74, preferably a dual-action cylinder 74, of the build platform lifting device 40. The construction container lifting device 30 is here completely extended, so that the construction container 100 located thereon reaches the construction container unpacking position P2. While the build platform lifting device 40 starts at the same time as the construction container lifting device 30, its structural design causes it to only contact the build platform 102 once the construction container 100 has reached the construction container unpacking position P2.

This is achieved among other ways by having the build platform lifting device 40 here comprise a lifting table 41, in which the lifting cylinder 74 acts inclined relative to the vertical traveling direction, and thus has a longer pathway than the construction container lifting device 30, which here moves the construction container wall 101 into the construction container unpacking position P2 by means of four directly vertically moving lifting cylinders 31.

The build platform lifting device 40 here moves toward the top until such time as one of the control elements a, c required for the lifting process is no longer being activated, or until the structural design causes it to reach its end position.

This construction of the build platform lifting device 40 and construction container lifting device 30 thus makes it possible to move a construction container 100 to be emptied into a construction container unpacking position P2 of the construction container by means of just one shared lifting control signal AHS, BHS, and to move the build platform 102 located in the construction container wall 101 into the build platform unpacking position in a coordinated, time-delayed manner thereto.

The control device 50 shown on FIG. 7 can also be used to move the construction container 100 back into a construction container receiving position P1 as follows, for example to again remove the emptied construction container 100.

If the third control element b is activated for this purpose and if the doors 13T are closed, the AND gate 54 delivers a 1 at its output, as already described. As a result, an electronic or electrical build platform lowering control signal ASS is now sent to a second way valve 72. The second way valve 72, preferably a 2/2-way valve 72, is also exposed to compressed air via the compressed air source 70.

If the second way valve 72 has received the electronic build platform lowering control signal ASS, it converts the latter into a hydraulic build platform lowering control signal ASS′, and the path for the compressed air is opened up. This compressed air now flows in on the opposite side being acted upon to move up the build platform 102. As a result, the compressed air now presses in the opposite direction of the cylinder 74, and the build platform lifting device 40 again moves from the build platform unpacking position P4 into a position in which the build platform 102 is in its lowermost position in the construction container 100.

In this position, a contact element 76 on the piston 78 of the cylinder affects a roller lever valve 75, either triggering or switching the latter. As soon as the roller lever valve 75 has been triggered, compressed air flows into the cylinder 73 of the construction container lifting device 30, as a result of which the cylinder receives a pneumatic construction container lowering control signal BSS' (delayed relative to the build platform lowering control signal ASS′). Here as well, the compressed airflows on the opposite side being acted upon to move up the construction container 100. In other words, the cylinder 73 or construction container lifting device 30 is now “pressed” downward or the construction container lifting device 30 now travels continuously from the construction container unpacking position P2 into the construction container receiving position P1. The construction container 100 along with the build platform 102 can only be removed once the construction container lifting device 30 is once again in the construction container receiving position P1.

Let it be noted at this juncture that the actuator illustrated on FIG. 7 is only a very rough schematic depiction, and any components required for actuating the construction container lifting device 30 and build platform lifting device 40 are thus not shown. For example, no relief valves were shown either, which are required to move the pistons 77, 78 of the cylinders 73, 74 of the lifting devices 30, 40 out and back in again.

As must also be mentioned, the lifting processes and lowering processes described above for the construction container 100 in the unpacking device 1 as well as the build platform 102 can be stopped at any time by no longer activating the control element a, b, c required for the lifting process and/or lowering process.

Finally, let it be noted yet again that the devices and methods described in detail above only represent exemplary embodiments, which the expert can modify in a variety of ways, without departing from the area of the invention. As explained above, verifying that all conditions are satisfied for moving a construction container is done inside of the control device. For example, this verification can also take place outside of a control device, e.g., in a logic circuit in or on the user interface. However, even a combination of these variants is possible. Any combination of the aforementioned variants of software or electronically and/or electrically operated control devices and hydraulically and/or pneumatically operated control devices is likewise possible. Furthermore, the use of the indeterminate article “a” or “an” does not mean that the features in question cannot be present repeatedly.

### REFERENCE LIST

1 Unpacking device
2 Receiving chamber
3 Unpacking chamber
4 Residual powder chamber
5 Partition wall
5S Insertion rail
6 Transfer opening/passage
7 Sieving area/sieving device/sieve
8 Vacuuming device
8R Suction tube
9 Vacuuming opening
10 Line
11 Engagement area
12 Lamellae
13 Loading openings
13T Doors
14 Doors
15, 16 Handles
17 Pump
18 Cover
19 Window
20 Sensor
21, 22 Centering elements
23 Hinge
24 Construction container lifting device
30 Lifting cylinder/hydraulic stamp
31 Cylinder housing
32 Cylinder housing
33 Piston
34 Support surfaces
40 Build platform lifting device
41 Lifting table
42 Support plate
43 Scissor axis
44 Rollers
45 Sliding rail
46 Leg/lever
50 Control device
50e Control device electrical/electronic
50p Control device pneumatic
51 Evaluation device
52, 53, 54 AND gate
60 Powder receiving box
61 Rollers
70 Compressed air source
71, 72 Way valve
73, 74 Cylinder
75 Roller lever valve
76 Contact element
77, 78 Piston
80 User interface
100 Construction container/switching frame
101 Construction container wall
102 Build platform
103 Outer upper edge
104 Lower edge
105 Gasket
106 Holding frame
a, b, c Control elements/pushbuttons
AB Unpacking area
AHS, AHS' Control signal/build platform lifting control signal
ASS, ASS' Control signal/build platform lowering control signal
Ax Axis
B Component
BHS, BHS' Control signal/construction container lifting control signal
BSS, BSS' Control signal/construction container lowering control signal
HS Lifting control command
OB Smallest side length
OL Maximum side length
P Unsolidified construction material/powder
P1 Construction container receiving position
P2 Construction container unpacking position
P3 Build platform initial position
P4 Build platform unpacking end position
RaB Smallest outer side length
RaL Maximum outer side length
SS Lowering control command
VS Pump control signal

1. An unpacking device for a construction container of a device for additively fabricating manufacturing products, the construction container of which has a continuous construction container wall and a height-adjustable build platform mounted therein,
wherein the unpacking device comprises at least the following:
a receiving chamber for receiving a construction container,
an unpacking chamber located above the receiving chamber,
a partition wall between the receiving chamber and unpacking chamber with a transfer opening,
a construction container lifting device located in the receiving chamber, which is designed to move the construction container from a construction container receiving position into a construction container unpacking position,
a build platform lifting device located in the receiving chamber, which is designed to move a build platform from a build platform initial position into a build platform unpacking position, and
a control device for outputting at least one control signal to the construction container lifting device and the build platform lifting device.

2. The unpacking device according to claim 1, wherein the unpacking device has a user interface, which is coupled with the control device, so as to output at least one lifting control command or at least one lowering control command to the control device.

3. The unpacking device according to claim 1, wherein the control device is designed, upon receiving one or several lifting control signals, to
send a construction container lifting control signal to the construction container lifting device, so as to move a construction container located on the construction container lifting device from the construction container receiving position into the construction container unpacking position, and
send a build platform lifting control signal to the build platform lifting device, so as to automatically move the build platform of the construction container from the build platform initial position into a build platform unpacking position by means of the build platform lifting device,
wherein the control device is designed to move the build platform of the construction container into the one build platform unpacking position only if the construction container has essentially reached the construction container unpacking position.

4. The unpacking device according to claim 1, wherein the control device is designed, upon receiving one or several lowering control signals, to
send a build platform lowering control signal to the build platform lifting device, so as to move the build platform of a construction container located on the construction container lifting device from a build platform unpacking position into the build platform initial position by means of the build platform lifting device, and
send a construction container lowering control signal to the construction container lifting device, so as to automatically move the construction container from the construction container unpacking position into the construction container receiving position,
wherein the control device is designed to move the construction container away from the construction container unpacking position only if the build platform of the construction container has already moved downward a bit in the construction container.

5. The unpacking device according to claim 1, wherein the control device and/or the user interface are designed in such a way as to output a construction container lifting control signal and/or a build platform lifting control signal, only when there are synchronized activations of at least two separate control elements and/or when there is a simultaneous activation of the user interface with both hands.

6. The unpacking device according to claim 1, wherein the construction container lifting device has at least two lifting cylinders.

7. The unpacking device according to claim 1, wherein the build platform lifting device has at least one lifting table.

8. The unpacking device according to claim 1, wherein the transfer opening is designed in such a way as to completely enclose the side walls of a construction container wall of a construction container adjacent to the partition wall when the construction container is in the construction container unpacking position.

9. The unpacking device according to claim 1, wherein the unpacking device has a residual powder chamber, below the unpacking chamber and next to the receiving chamber, wherein the residual powder chamber has a powder receiving box and/or a powder removal device.

10. The unpacking device according to claim 1, wherein the unpacking chamber is connected with the residual powder chamber by a sieving area in and/or below the partition wall.

11. The unpacking device according to claim 1, wherein the unpacking device has a vacuuming device configured to vacuum powder dust out of the unpacking chamber.

12. The unpacking device according to claim 11, wherein the vacuuming device has vacuuming openings located above an unpacking area.

13. The unpacking device according to claim 12, wherein the vacuuming device has a plurality of vacuuming openings distributed along a primary extension of the unpacking device essentially along the complete primary extension within the unpacking device.

14. The unpacking device according to claim 11, wherein the receiving chamber has centering elements, so as to position a construction container received in the receiving chamber on the construction container lifting device.

15. A method for controlling an unpacking device for a construction container of a device for additively fabricating manufacturing products, wherein the construction container has a continuous construction container wall and a height-adjustable build platform mounted therein, wherein the unpacking device has a receiving chamber for receiving a construction container, an unpacking chamber (3) located above the receiving chamber, and a partition wall between the receiving chamber and unpacking chamber with a transfer opening, as well as a construction container lifting device and a build platform lifting device,
wherein the method consists of at least the following steps:
Receiving a construction container in the receiving chamber,
outputting at least one control signal to the construction container lifting device and to the build platform lifting device, so that the construction container located on the construction container lifting device is moved from a construction container receiving position into a construction container unpacking position, and the build platform of the construction container is automatically moved from the build platform receiving position into a build platform unpacking position by means of the build platform lifting device in a time-coordinated manner.
